(19) United States
(12) Patent Application Publication
(10) Pub. No.: US 2017/0183997 A1
(43) Pub. Date: Jun. 29, 2017

(54) METHOD OF IMPROVING EXHAUST EMISSION OF A COMBUSTION ENGINE, AND COMBUSTION ENGINE

(71) Applicant: AUDI AG, lngolstadt (DE)

(72) Inventors: CHRISTOPH TAPP, Bad Friedrichshall (DE); TORSTEN RAUSCH, Nordheim (DE)

(73) Assignee: AUDI AG, lngolstadt (DE)

(21) Appl. No.: 15/390,159

(22) Filed: Dec. 23, 2016

(30) Foreign Application Priority Data
Dec. 24, 2015 (DE) 10 2015 016 977.7

(51) Int. Cl. F01N 3/20; F01N 3/02; F02B 37/00; F01N 9/00

(52) U.S. Cl. CPC F01N 3/2006; F01N 9/00; F01N 3/02; F02B 37/002

(57) ABSTRACT

In a method of reducing pollutants of a combustion engine, exhaust gas, generated by a cylinder of the combustion engine, is fed to an exhaust gas aftertreatment system as a function of a predefined condition solely via a first exhaust channel which communicates with a first one of first and second exhaust valves of the cylinder. The first exhaust channel is hereby coated, at least in part, by a thermally insulating layer selected such that a heat input is transmitted to the exhaust gas aftertreatment system which heat input is greater than a heat input in a second exhaust channel communicating with a second one of the first and second exhaust valves. The predefined condition is defined as a function of a coolant temperature of the combustion engine.

### CROSS-REFERENCES TO RELATED APPLICATIONS

This application claims the priority of German Patent Application, Ser. No. 10 2015 016 977.7, filed Dec. 24, 2015, pursuant to 35 U.S.C. 119(a)-(d), the disclosure of which is incorporated herein by reference in its entirety as if fully set forth herein.

### BACKGROUND OF THE INVENTION

The present invention relates to a method of reducing pollutants of a combustion engine, and to a combustion engine.

The following discussion of related art is provided to assist the reader in understanding the advantages of the invention, and is not to be construed as an admission that this related art is prior art to this invention.

Combustion engines produce exhaust gases which normally are treated in an exhaust gas aftertreatment system because of their environmentally hazardous properties. For example, the exhaust gases are further oxidized in the aftertreatment system to reduce their potential of harming the environment. As the aftertreatment system requires a high operating temperature to properly treat the exhaust gas, aftertreatment of exhaust gas is inadequate during a cold start phase of the combustion engine. There is thus a need for a rapid heat up of an exhaust gas aftertreatment system in a cold start situation.

It would therefore be desirable and advantageous to address this problem and to obviate other prior art shortcomings.

### SUMMARY OF THE INVENTION

According to one aspect of the present invention, a method of reducing pollutants of a combustion engine includes feeding exhaust gas, generated by a cylinder of the combustion engine, to an exhaust gas aftertreatment system as a function of a predefined condition solely via a first exhaust channel which communicates with a first one of first and second exhaust valves of the cylinder and is coated, at least in part, by a thermally insulating layer selected such that a heat input is transmitted to the exhaust gas aftertreatment system which heat input is greater than a heat input in a second exhaust channel communicating with a second one of the first and second exhaust valves, and defining the predefined condition as a function of a coolant temperature of the combustion engine.

A method in accordance with the present invention takes an approach to increase a heat input into an exhaust gas aftertreatment system of a combustion engine by routing exhaust from the combustion engine, in particular during a cold start phase, solely through an exhaust channel into the exhaust gas aftertreatment system as a function of a predefined condition, such as, e.g., a coolant temperature. The exhaust channel is hereby coated or thermally insulated such that a heat input by exhausts of the combustion engine into the exhaust channel are prevented or reduced compared to an exhaust channel without coating, so that the heat input by the exhausts into the exhaust gas aftertreatment system is increased.

In order to route exhausts produced by the combustion engine as a function of a predefined condition, i.e. selectively or dynamically as a function of a predefined condition exclusively via the appropriately coated, thermally insulated exhaust channel and to increase heat input into the exhaust gas aftertreatment system, corresponding exhaust valves of a cylinder of the combustion engine are activated or deactivated as a function of the predefined condition. Thus, especially when heat energy should be supplied to the exhaust gas aftertreatment system to shorten the cold start phase for example or to induce self-cleaning of the exhaust gas aftertreatment system, exhausts are exclusively routed via the coated exhaust channel by activating only the exhaust valve that is associated to this exhaust channel.

To lower a temperature in respective regions of the combustion engine, like, e.g. in the exhaust gas aftertreatment system, provision may be made to activate a second exhaust valve of the cylinder of the combustion engine as a function of a further predefined condition, such as, e.g. a current temperature of the exhaust gas aftertreatment system. Thus, exhausts produced by the cylinder can be discharged, at least in part, via the second exhaust valve and a second exhaust channel which is associated to the second exhaust valve and is devoid of an insulating layer. In other words, heat energy of exhaust gas flowing through the second exhaust channel is absorbed by the second exhaust channel to thereby cool down the exhaust gas. As a result, heat input to further components of the combustion engine by exhaust gas is reduced compared to a transport via a thermally insulated exhaust channel.

In the description, the term “thermally insulated layer” relates to any layer which is capable of reducing a transfer of heat from the exhausts to a structure that forms an exhaust channel or to an environment of the exhaust channel and which is capable of maintaining a heat energy in the exhaust as constant as possible and keeping a cool down of exhaust to a minimum.

In the description, the terms “exhaust channel” and “structure forming an exhaust channel” are to be understood as equivalent or synonymous. Likewise the terms “exhaust or exhausts” and “exhaust gas” are to be understood as equivalent or synonymous.

A thermally insulating layer can be applied to an inner part of the exhaust channel in contact with the exhaust. Thus, the thermally insulating layer can be made reflective, so that heat input into the exhaust channel is avoided or significantly reduced. It is also conceivable to apply the thermally insulating layer to an outer part of the exhaust channel in contact with the environment of the exhaust channel. Furthermore, the thermally insulating layer can be configured such that heat input from the exhaust channel to an environment is reduced or even prevented, so that heat energy in the exhaust channel and thus in the exhaust is retained.

The exhaust channel may also be wound with insulating fabric layers so as to maintain heat energy in the exhaust channel and to prevent exhaust to cool down.

It is also conceivable to coat or surface-treat, e.g. polishing, the exhaust channel in its interior with varnish or an alloy so as to maintain heat energy in the exhaust channel and to prevent exhaust to cool down. Advantageously, the exhaust channel has on the inside a reflective surface capable of reflecting heat radiation emitted by the exhaust back to the exhaust.

According to another advantageous feature of the present invention, exhaust gas can be discharged from the cylinder, at least in part, via the second one of the first and second exhaust valves and the second exhaust channel as a function of a further predefined condition. As a result, heating of the exhaust gas aftertreatment system above a predefined temperature level can be prevented, when the second exhaust valve of the cylinder of the combustion engine is activated as a function of the further predefined condition, such as, e.g., as a function of current exhaust values or elapse of a defined time interval since a start of the combustion engine. Exhaust from the cylinder can thus be discharged via the second exhaust channel and heat input into the exhaust gas aftertreatment system can be reduced because of the absence of a thermal insulation of the second exhaust channel, i.e. more heat is absorbed by the second exhaust channel than in the first exhaust channel.

Provision may be made for supply of exhaust via at least one of the first and second exhaust channels to a number of turbochargers to thereby drive them. A turbocharger can be operated most efficiently, when exhausts are fed via the first exhaust channel, because this exhaust channel conducts exhausts at a high heat input, i.e. exhausts with high enthalpy. In addition, a turbocharger can be evenly heated by exhausts with high enthalpy or high heat input, so that thermal stress and resultant material fatigue are reduced.

The predefined condition can be selected in dependence on a current operating mode of a valve control by which a movement of the first exhaust valve and the second exhaust valve can be selected. In this way, supply of heat energy into an exhaust gas aftertreatment system via the thermally insulated first exhaust channel can be implemented by a control logic of the valve control. Thus, heat input into the exhaust gas aftertreatment system is especially high, when the valve control activates the first exhaust valve only for flow of exhausts through the thermally insulated first exhaust channel. In particular, when a valve control is involved for controlling multistage charged combustion engines with a number of turbochargers, the increased heat input into the exhaust gas aftertreatment system can be coupled to an operation with only one turbocharger, e.g. at low rotation speeds.

It is also conceivable to select the predefined condition in dependence on an operating parameter of the combustion engine selected from the group consisting of current rotation speed, engine temperature, temperature of exhaust gas aftertreatment system, lambda value of a lambda probe, and coolant temperature. It will be understood by persons skilled in the art that the predefined condition can be selected by any appropriate condition that relates to an operating situation of a combustion engine. Examples include information about the actual exhaust quality, such as, e.g., a lambda value of a lambda probe which is arranged in an exhaust path downstream of the exhaust gas aftertreatment system so as to control heat input into the exhaust gas aftertreatment system in accordance with the method of the invention.

According to another advantageous feature of the present invention, the first exhaust channel can be configured such that the heat input from the cylinder into the exhaust gas aftertreatment system is at a maximum.

The use of an exhaust channel to provide a direct connection from a corresponding cylinder of a combustion engine to an exhaust gas aftertreatment system makes it possible to minimize cooling of exhausts, generated by the cylinder, on their way to the exhaust gas aftertreatment system, and to maximize a heating of the exhaust gas aftertreatment system. A direct connection, e.g. along a straight line, is beneficial to efficiently transfer heat energy to the exhaust gas aftertreatment system, as opposed to an exhaust channel with windings which rapidly cool down exhausts.

According to another aspect of the present invention, a combustion engine includes a cylinder having first and second exhaust valves, an exhaust gas aftertreatment system receiving exhaust gas from the cylinder as a function of a predefined condition solely via a first exhaust channel which communicates with a first one of first and second exhaust valves of the cylinder, and a thermally insulating layer applied on the first exhaust channel and selected such that a heat input is transmitted to the exhaust gas aftertreatment system which heat input is greater than a heat input in a second exhaust channel communicating with the second one of the first and second exhaust valves, wherein the predefined condition is defined as a function of a coolant temperature of the combustion engine.

According to another advantageous feature of the present invention, the combustion engine can include a control device to control the first and second exhaust valves such that as a function of the predefined condition the first exhaust valve opens to allow exhausts, generated by the cylinder, to flow to the exhaust gas aftertreatment system via the first exhaust channel. The control device can thus be used to control heat input into the exhaust gas aftertreatment system by correspondingly activating or deactivating the first exhaust valve.

According to another advantageous feature of the present invention, the combustion engine can include first and second turbochargers, with the control device being configured to operate the first exhaust valve such that during a cold start phase of the combustion engine exhaust gas flows in the first exhaust channel to the exhaust gas aftertreatment system via the first turbocharger only.

According to another advantageous feature of the present invention, the combustion engine can be constructed in the form of a diesel engine.

### BRIEF DESCRIPTION OF THE DRAWING

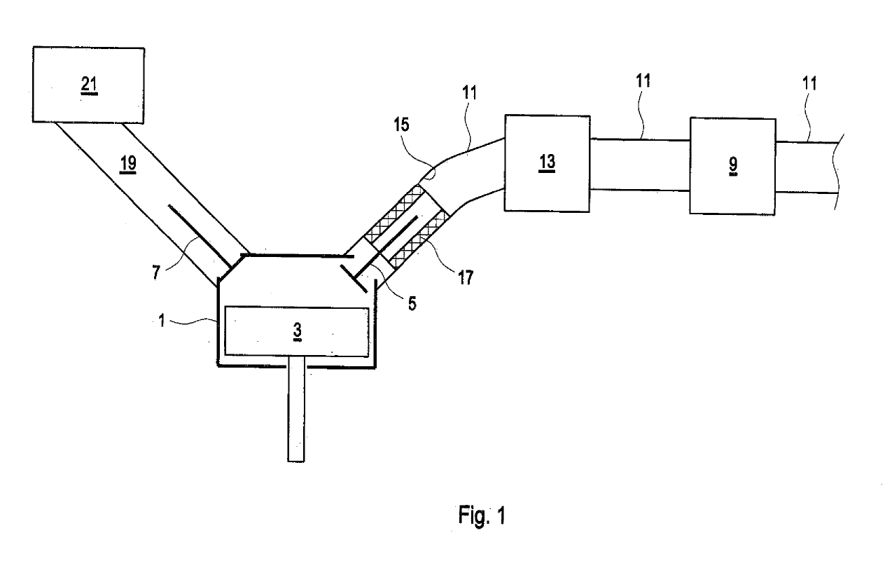

Other features and advantages of the present invention will be more readily apparent upon reading the following description of currently preferred exemplified embodiments of the invention with reference to the accompanying drawing, in which the sole FIG. 1 shows a schematic illustration of an exemplified embodiment of a combustion engine according to the present invention.

### DETAILED DESCRIPTION OF PREFERRED EMBODIMENTS

The depicted embodiment is to be understood as illustrative of the invention and not as limiting in any way. It should also be understood that the figure may not necessarily be to scale. In certain instances, details which are not necessary for an understanding of the present invention or which render other details difficult to perceive may have been omitted.

Turning now to FIG. 1, there is shown a schematic illustration of an exemplified embodiment of a combustion engine according to the present invention. The combustion engine, e.g. a diesel engine, is shown here only to the extent that is necessary for the understanding of the present invention. It will be appreciated by persons skilled in the art that the combustion engine must contain much mechanical apparatus which does not appear in the foregoing Figure. However, this apparatus, like much other necessary apparatus, is not part of the invention, and has been omitted from FIG. 1 for the sake of simplicity.

FIG. 1 shows a cylinder 1 of the combustion engine. Arranged in the cylinder 1 are a piston 3 as well as a first exhaust valve 5 and a second exhaust valve 7. In order to subject exhausts, produced in the cylinder 1 during operation of the combustion engine, to an aftertreatment as rapidly and efficiently as possible, an exhaust gas aftertreatment system 9 has to be brought to operating temperature as rapidly as possible after stating the combustion engine. For this purpose, provision is made to maximize a heat input by exhausts into the exhaust gas aftertreatment system 9 by only opening the exhaust valve 5 to allow a flow of exhaust gas to exit the cylinder 1 exclusively via an exhaust channel 11 which is associated to the exhaust valve 5. On its way to the exhaust gas aftertreatment system 9, exhausts flow initially to a turbocharger 13 and then to the exhaust gas aftertreatment system 9 for a time period long enough for the temperature in the exhaust gas aftertreatment system 9 to reach a desired predefined temperature.

The exhaust channel 11 has in its interior, i.e. on an inner side 15, a thermal insulating layer 17 which minimizes or even prevents a transfer of heat energy from exhaust gas within the exhaust channel 11, i.e. from the exhaust gas to a material delimiting the exhaust channel 11. Thus, heat energy in the exhaust retained in the exhaust gas and can be used for heating the exhaust gas aftertreatment system 9. The insulating layer 17 may be a layer of enamel which exhibits extremely poor heat conduction. An example of an enamel layer is known under the designation NemaCoat™, distributed by Nemak Europe GmbH. It is, of course, also conceivable that the insulating layer 17 includes ceramic insets, so-called portliners.

As soon as the exhaust gas aftertreatment system 9 has reached operating temperature, the second exhaust valve 7 can be activated to open in order to allow exhaust to also exit the cylinder 1 and to flow in a second exhaust channel 19 for operation of a turbocharger 21 which is in communication with the exhaust channel 19. In this way, the combustion engine can be operated efficiently and at high performance. The heating phase, during which an input of heat energy into the exhaust gas aftertreatment system 9 takes place, is coupled to an operating mode of a control of the first exhaust valve 5 and the second exhaust valve 7, which control in turn can be controlled as a function of a current coolant temperature for example.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A method of reducing pollutants of a combustion engine, said method comprising:
feeding exhaust gas, generated by a cylinder of the combustion engine, to an exhaust gas aftertreatment system as a function of a predefined condition solely via a first exhaust channel which communicates with a first one of first and second exhaust valves of the cylinder and is coated, at least in part, by a thermally insulating layer selected such that a heat input is transmitted to the exhaust gas aftertreatment system which heat input is greater than a heat input in a second exhaust channel communicating with a second one of the first and second exhaust valves; and
defining the predefined condition as a function of a coolant temperature of the combustion engine.

2. The method of claim 1, wherein the second exhaust channel is configured in the absence of an insulating layer.

3. The method of claim 1, further comprising discharging exhaust gas from the cylinder at least in part via the second one of the first and second exhaust valves and the second exhaust channel as a function of a further predefined condition.

4. The method of claim 1, wherein the first exhaust channel is configured such that the heat input from the cylinder into the exhaust gas aftertreatment system is at a maximum.

5. A combustion engine, comprising:
a cylinder having first and second exhaust valves;
an exhaust gas aftertreatment system receiving exhaust gas from the cylinder as a function of a predefined condition solely via a first exhaust channel which communicates with a first one of first and second exhaust valves of the cylinder; and
a thermally insulating layer applied on the first exhaust channel and selected such that a heat input is transmitted to the exhaust gas aftertreatment system which heat input is greater than a heat input in a second exhaust channel communicating with a second one of the first and second exhaust valves,
said predefined condition being defined as a function of a coolant temperature of the combustion engine.

6. The combustion engine of claim 5, further comprising a control device configured to control the first and second exhaust valves such that as a function of the predefined condition the first exhaust valve opens to allow exhaust gas, generated by the cylinder, to flow to the exhaust gas aftertreatment system via the first exhaust channel.

7. The combustion engine of claim 6, further comprising first and second turbochargers, said control device being configured to operate the first exhaust valve such that during a cold start phase of the combustion engine exhaust gas flows in the first exhaust channel to the exhaust gas aftertreatment system via the first turbocharger only.

8. The combustion engine of claim 5, wherein the thermally insulating layer is applied upon an inner surface of the first exhaust channel.

9. The combustion engine of claim 5, wherein the thermally insulating layer is applied upon an outer surface of the first exhaust channel.

10. The combustion engine of claim 5, constructed in the form of a diesel engine.
